(19) United States
(12) Patent Application Publication
(10) Pub. No.: US 2008/0110291 A1
(43) Pub. Date: May 15, 2008

(54) Ventilated bicycle handlebars, handlebar grips and gloves

(76) Inventor: Christopher J. Vitek, Ellicott City, MD (US)

Correspondence Address: Christopher J. Vitek, 5115 Little Creek Drive, Ellicott City, MD, 21043, US

(21) Appl. No.: 11/979,966

(22) Filed: Nov. 13, 2007

Related U.S. Application Data
(60) Provisional application No. 60/858,226, filed on Nov. 13, 2006.

(51) Int. Cl. B62K 21/26; B62K 21/12; A41D 19/00

(52) U.S. Cl. 74/551.9; 2/159

(57) ABSTRACT

A ventilated handlebar, such as a bicycle handlebar is disclosed. The ventilated handlebar comprises an air-intake aperture that is oriented in the direction of forward travel of the vehicle and an air distribution channel that is connected to the air-intake apertures and is also connected to a series of air-discharge openings to ventilate the hand grip area of the handlebar, thereby promoting a cooling effect on the rider's palms resulting in cooling effect on the rider's body thereby reducing the rider's fatigue.

This application claims the benefit of U.S. Provisional Patent Application No. 60/858,226, filed on Nov. 13, 2006.

### FIELD OF THE INVENTION

The present invention relates to a ventilated bicycle handlebar that provides a flow of air onto a bicycle rider's hands to improved body temperature control and comfort. A flow of air is passed through air-intake ventilation openings on the handlebar to air-discharge ventilation openings on the grip portion of the handlebars. Another aspect of this invention are ventilated handlebar grips that allow air that is exhausted from the handlebars to flow over the rider's palms to improve body temperature control and comfort. Another aspect of the invention is to provide ventilated gloves with unique ventilated palms that allow air to flow to the palms of a cyclist to enable improved body-temperature control and comfort.

### BACKGROUND OF THE INVENTION

It is well known that bicycle riders and athletes in general are prone to fatigue due to overheating. The human body attempts to counter the overheating through perspiration and changes in blood circulation to cool the athlete's body. The palms of the human hand are one of those areas where heat is exchanged more efficiently than other parts of the body. For bicyclists and other athletes that wear gloves during bicycle riding or general exercising, the palms are covered. For bicyclists who are either wearing gloves or riding bare handed without gloves, the palms are also engaged tightly on the handlebar grips of the bicycle so that there is little chance of cooling the palms while riding with a conventional bicycle handlebar. There exists a real need to provide a cooling effect to bicyclists that are exercising vigorously. Ventilated handlebars, handlebar grips and, optionally in combination with ventilated gloves, can be used to provide a flow of air over the athlete's palms, thereby cooling the person engaged in the activity of riding a bicycle more efficiently than on a traditional handlebar and reducing their fatigue.

Cycling is an activity of increasing popularity. For those who routinely practice intense physical activity when riding a bicycle, such as long distance riding and trail cycling, exertion can cause an increase in both interior and external body temperature which increases muscle fatigue for the bicycle rider. These reports are useful information to enterprise managers. They are unique in that they are able to store the presence data which is typically discarded by the users of SIP-based products. Another aspect of this invention that is unique is the display of aggregate or segmented data about multiple computer. telephone and/or other business machine utilization in real-time and on a historical basis.

It is desirable that a tool or a process be developed that will allow more efficient cooling to be imparted to the bicyclist. Therefore a modification or addition of equipment on a bicycle is desired to provide comfort to one's person by more efficiently cooling the bicycle rider during demanding physical activity. One way to achieve this is to provide a reduction in body temperature or more simply, cooling to the body. It has been scientifically proven that one way to reduce body heat and provide cooling to the body is to apply a cooling technique to the palms of one's hands whereby the interior flow of blood, which is nearest the surface of the skin in the palm, can easily be cooled and transfer this temperature reduction to the remainder of the body. This can best be accomplished by blowing air unto the surface of one's palms to introduce a cooling effect.

Attempts to ventilate a bicyclist's equipment to achieve comfort is disclosed in U.S. Pat. No. 4,679,335 which teaches the use of a vented bicycle shoe comprising air scoops at the front of the shoe that direct air channels formed in the inner base of the shoe and extend toward the heel. This design provides a cooling action on the foot of the cyclist. A ventilated bicycle seat is disclosed in U.S. Pat. No. 6,629,728 which provides comfort while sitting on a bicycle.

There are limits to the effectiveness of ventilated shoes and ventilated bicycle seats. It is, therefore, desirable to effectively impart cooling to one's palm while riding a bicycle to achieve a cooling effect. Research has shown that the human body reduces blood circulation near the skin when that part of the body is exposed to the cooling effect of wind or cool air. Research has also shown that the palms of the human hand are not prone to this reduction in blood flow when cooled. Therefore, the blood following through the palm area is cooled and this temperature drop is transported throughout the body due to blood flow. Thus cooling of the palms is critical to cooling the human body and reducing fatigue.

The present invention relates to a ventilated bicycle handlebar, ventilated handlebar grips, and, optionally, ventilated gloves that can be used separately or as a complete system to provides a flow of air onto a bicycle rider's palms. More particularly, the invention encompasses a ventilated handlebar wherein the handlebar is fitted an air-intake components which transfers air into the hollow interior section of a bicycle handlebar so that the incoming air flows through the hollow interior of the handlebars and exits the hollow interior through air-discharge vents or apertures in the handlebar grip areas. If ventilated handlebar grips are enclosing the handle grip areas, then the air flows through vents or apertures located in the handlebar grips onto the palms of the rider. The flow of air onto the palms of the cyclist provides a cooling effect, thereby providing for improved body temperature control, reduced fatigue and comfort for the rider. If the bicycle rider is wearing ventilated gloves that contain holes or perforations on the palms, the exiting air from the ventilated handlebars flows onto the palms of a bicyclist through the holes or perforations positioned on the palms of the ventilated gloves. It is noteworthy that there are other ventilated gloves available today; however, these gloves offer ventilation on the back of the hand not the palm.

In the present invention, air is permitted to enter the handlebar through an air-intake component which may be an aerodynamic air scoop, holes, apertures, perforations, open slits or a combination thereof located on the handlebar. The air then flows through the hollow interior of the handlebar, where the hollow interior portion of the handlebar functions as an air distribution channel, and consequently flows on the bicyclist's palms through a plurality of air-discharge openings disposed in the handlebar grip area. Optionally, a handlebar grip is engaged with the handlebar grip area and the handlebar grip is a rubber, leather or leather-like sheath for the handlebar hand grip area that contains a plurality of air-discharge openings. The air-discharge openings are aligned with the air-discharge openings disposed on the handlebar grip area of the handlebar so that the air discharged from the air-discharge openings flows through the handlebar grip and subsequently over the bicycle rider's palms. The preferred placement of the air-discharge openings are the handlebar grip areas and other positions on the handlebars where the bicyclist may place one's hands.

### SUMMARY OF THE INVENTION

It is an object of this invention to provide ventilated handlebars, especially for bicycles, that have air-intake components that cause air to enter the hollow interior of the handlebar which functions as an air distribution channel and permits the free flow of air from the air-intake components to the handlebar grip areas. The preferred air-intake component is a plurality of apertures. The supply of air is provided by the forward travel of the bicycle. The air-intake components are oriented in the direction of the travel of the bicycle so that air is able to flow into the air distribution channel. In the case of stationary bicycles used for exercise, the air supply may be pumped into the air distribution channel through an air-intake aperture by a fan, blower, or air pump. The purpose of the invention is to reduce bicycle rider's fatigue by cooling the palms of the rider's hands. This is achieved by providing a flow of air onto the cyclist's hands, especially the palm areas which are pressed against a hand grip when the person is riding a bicycle. This can best be accomplished by creating an air flow onto the bicyclist palms and the present invention resolves this by providing an air flow through the hollow portion of the handlebar with an exit of the air flow onto the bicyclist's hands. The air flow through the handlebar is best accomplished by forcing air into the hollow portion of the handlebars through an air-intake component which may be a series of perforations, holes or slits located on the front edge of the handlebars, or through an air scoop attached to the handlebar of the bicycle. The air flows through the air distribution channel defined by the hollow interior of the handlebars and then exits through the air-discharge openings or perforations positioned at the handlebar grip areas of the handlebar. The air then flows over the bicyclist's palms to cause a cooling effect.

It is another object of this invention to provide ventilated gloves that contain a series or plurality of apertures or holes positioned in the palm area of the glove where the total area of the apertures or holes are at least 30% and no more than 100% of the total fabric in the palm area of the glove. The air-discharged from the ventilated handlebar grips or handlebar grip area then flows through the gloves and cools the palms of the bicycle rider.

### BRIEF DESCRIPTION OF THE DRAWINGS

FIG. 1 is a frontal view of the ventilated handlebar illustrative of the type which is commonly used on mountain bikes.

FIG. 2 is an view of a ventilated handlebar illustrative of the type which is commonly associated with road or touring bikes.

FIG. 3 is an overview of a ventilated handlebar commonly known as a tri-athlete handlebar and an expanded view and cross section of aerodynamic scoops used as an air-intake component.

FIG. 4 is a frontal and cross-sectional view of a ventilated handlebar 1 with air-intake apertures in the form of slits 10 that collect air that is channeled through the hollow interior of the handlebar to ventilation holes 4 located handlebar grip 3.

FIG. 5 is a view of the palm side of a pair of ventilated glove 11 with perforated holes 12.

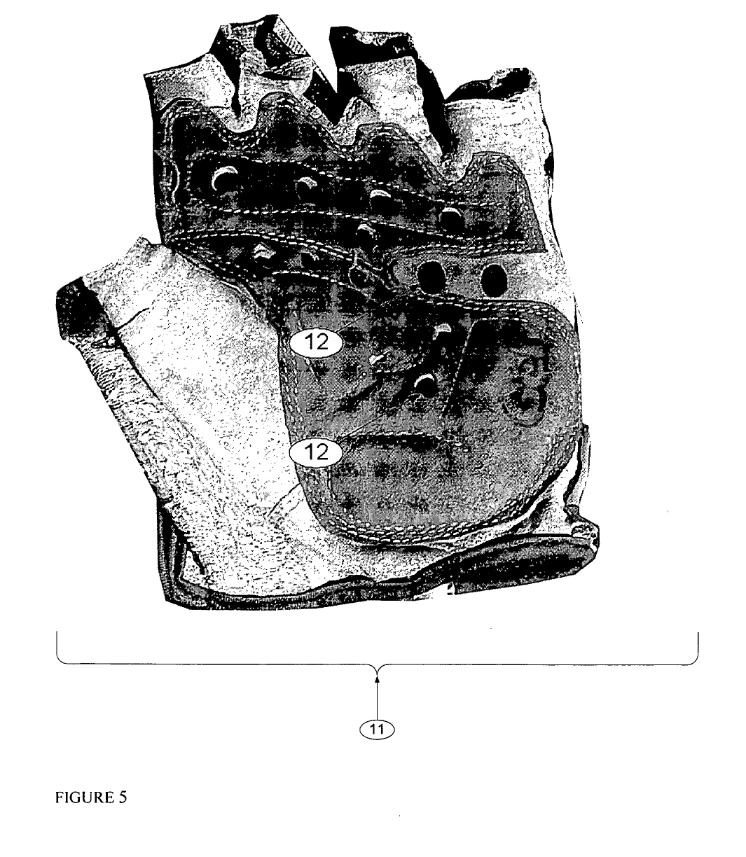

FIG. 6 is a photograph of a mountain bike handlebar illustrating the placement of the air-intake apertures 2 depicted in FIG. 1. The air-intake apertures 2 collect air that is then channeled through the hollow interior, or air distribution channel, of the handlebar to the handlebar grip area where it is discharged through air-discharge apertures.

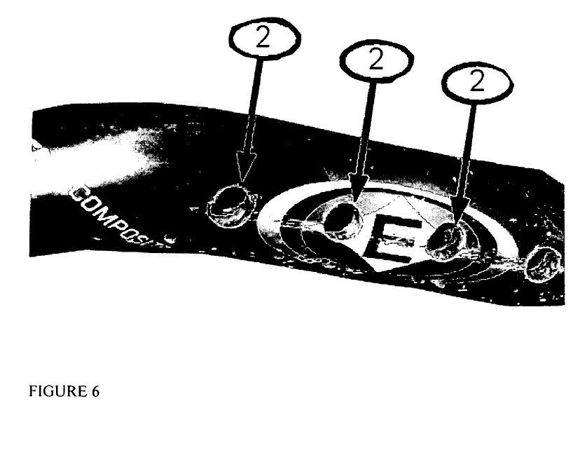

FIG. 7 is a photograph of the mountain bike handlebar in FIG. 6 illustrating the air-discharge apertures 4 located in the handlebar grip 3 as seen in FIG. 1.

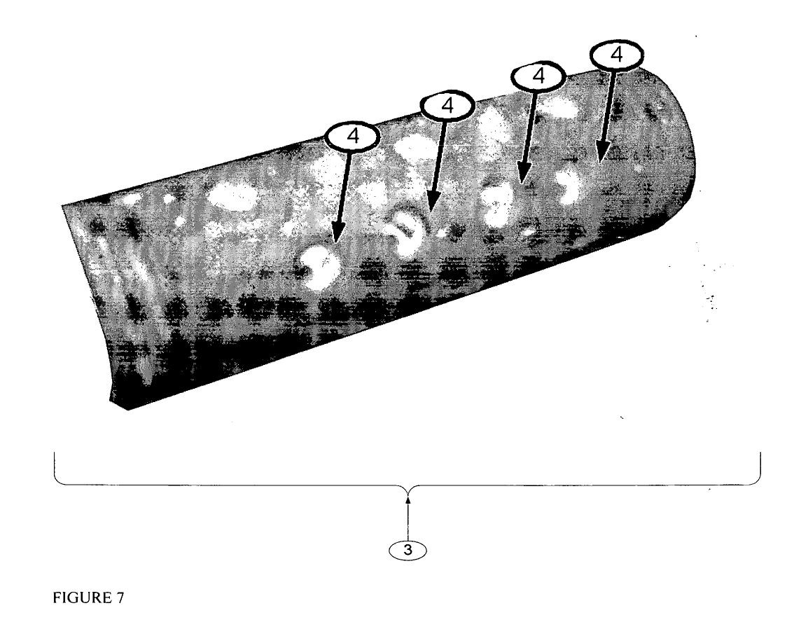

FIG. 8 is a drawing of the palm side of a ventilated glove 11. with perforated holes 12.

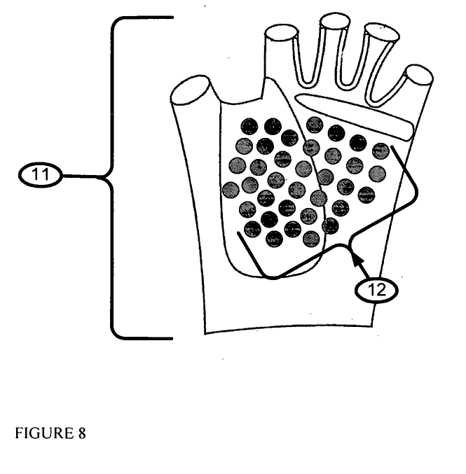

### DETAILED DESCRIPTION OF THE INVENTION

The embodiments shown in the Figures exemplify certain features of the ventilated handlebars and handlebar grips which may be used in combination with ventilated gloves. The invention will now be described in connection with preferred embodiments. These embodiments are presented to aid in an understanding of the present invention and are not intended to, and should not be construed to limit the invention in any way. All alternatives, modifications and equivalents that may become obvious to those of ordinary skill when reading the disclosure are included within the spirit and scope of the present invention.

It is an object of this invention to provide bicycle handlebars that comprise air-intake components that transfer or funnel air into the hollow interior of the handlebar, where said hollow interior functions as an air distribution channel allowing the air to flow freely to air-discharge openings in the handlebar grip areas. The air-intake components may be apertures or holes or open slits that extend from the exterior of the handlebar to the hollow interior of the handlebar. The air-intake apertures are oriented in the direction of the forward travel of the bicycle. This allows the air-intake openings to be pressurized by the forward motion of the bicycle, thus, forcing air into the internal air distribution channel. Additionally, the air-intake component may be an air scoop adjacent to an aperture or opening in the handlebar that funnels or channels air into the hollow interior or the handlebar otherwise known as the air distribution channel. The air-intake portion of the air scoop is oriented in the direction of the forward travel of the bicycle. The air distribution channel has a first portion and a second portion wherein the first part of the air distribution channel has an air-intake component for directing air into the channel and the second portion is engaged with an air-discharge opening or openings disposed on the hand grip area on the handlebar. Due to the shape of the handlebar, second portion of the air distribution channel is preferably engaged with a plurality of air-discharge openings disposed onto more than one hand grip areas on the handlebar. The purpose of the invention is to reduce bicycle rider fatigue by cooling the palms of the rider's hands. This is achieved by providing a flow of air onto the cyclist's palms, which are pressed against the handlebar grip area or handlebar handgrip when the person is riding a bicycle.

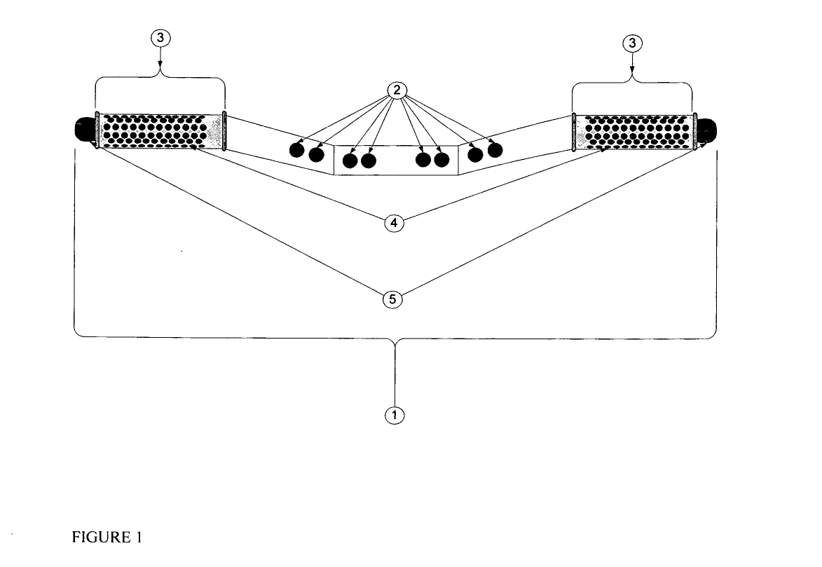

In FIG. 1, illustrative of handlebars associated with mountain bikes, a ventilated bicycle handlebar 1 has air-intake apertures 2 to allow air to enter into the hollow interior of the handlebar and flow through the air-discharge openings 4 in ventilated handlebar grips 3 to allow the discharge of air onto a cyclist's palms. Optionally, air scoops 5 are attached to the handlebar to collect and channel air into the hollow interior of the handlebar.

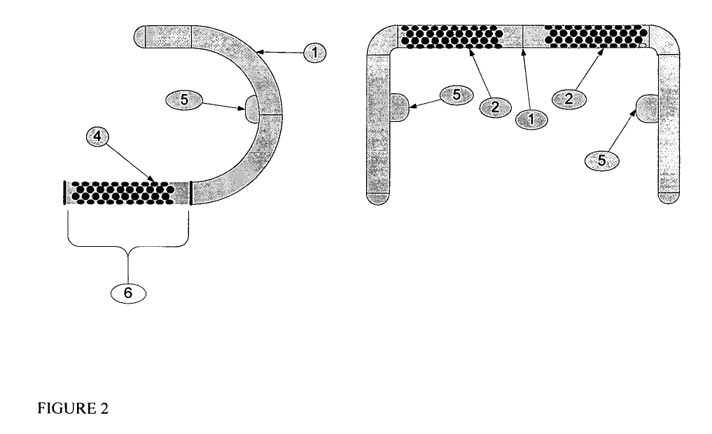

In FIG. 2, illustrative of a different style of handlebars associated with road bikes, air-intake apertures 2 are located on the handlebar 1. Additionally, air-intake scoops 5 are mounted to the bars just to the inside of the center portion of the arc that supports the drop portion of the handlebars. Air entering these holes or scoops is channeled through the hollow interior of the handlebar to air-discharge openings 4 located on the dropped section 6 of the handlebar where the cyclist usually places one's hands.

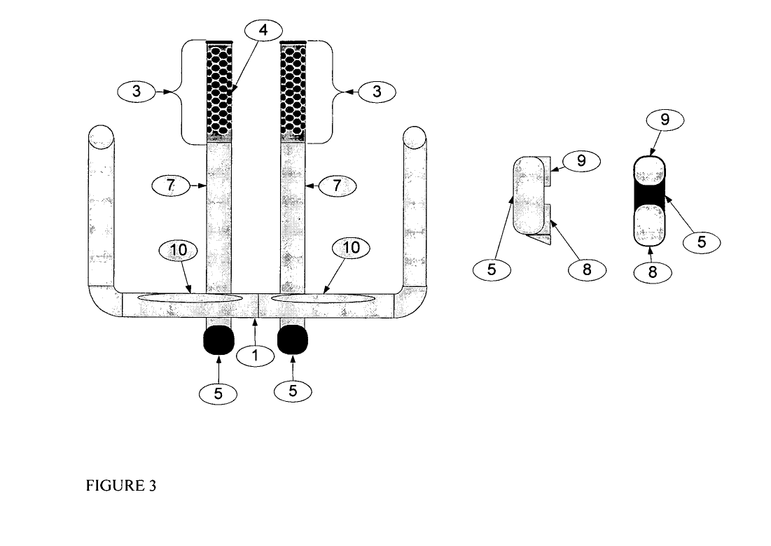

FIG. 3 is an example of the use of ventilated handlebars in a tri-athlete style, where the main handlebar 1 is attached to two center handlebars 7 that extend perpendicularly from the main handlebar. Air-discharge openings 4 are positioned on the center grip area 3 of the handlebars. Air scoops 5 that face in the direction of travel are mounted at the rear and underneath the center handlebars 7 to collect air that will be channeled through the hollow interiors of handlebars 7 to handlebar grips 3 that include air-discharge opening 4. A side and frontal profile of the scoops 5 shows the air-intake 8 of the scoop and the flange 9 for attachment to the center handlebars 7 to allow air to flow from the air-intake of the scoop to the hollow interior of the center handlebars 7. Air-intake apertures in the form of wide open slits 10 on the forward facing front of the handlebar collect air flowing through the hollow interior of the handlebar 1 for discharge through drop-down hand grips.

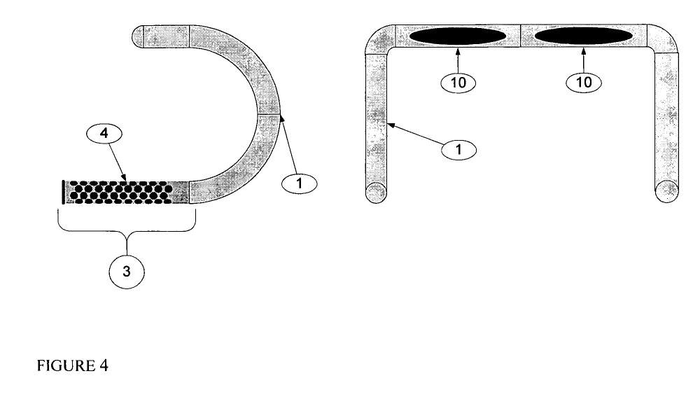

FIG. 4 illustrates a ventilated handlebar 1 with air-intake apertures in the form of slits 10 that collect air that is channeled through the hollow interior of the handlebar to air-discharge openings 4 located on handlebar grip 3.

For use with the ventilated handlebars and ventilated handlebar grip areas, this invention to provide ventilated gloves that allows the flow of air from the ventilated handgrips to flow thorough perforations in the glove's palm area and cool the palms of the bicycle rider, thereby allowing air to cool and dry the bicyclist's palms and hands. Thus, reducing body temperature and fatigue.

It is an object of the present invention to provide ventilated handlebars, handlebar grips to provide a cooling action for the comfort of the user during the use of the equipment associated with the handlebar.

It is an object of the present invention to provide ventilated bicycle handlebars, handlebar grips and ventilated gloves to support a cooling action for the comfort of a cyclist during use of the bicycle.

It is a further object of the invention to provide a ventilation system that utilizes air transferred from air-intake apertures, holes or scoops oriented in the direction of travel to an air distribution channel located within the bicycle handlebars and exhausting this air through air-discharge openings in the hand grip areas of the handlebars, thereby allowing air to cool and dry the bicycle-rider's palms to reduce fatigue.

It is a further object of the invention to provide a ventilation system that utilizes air captured through forward-facing scoops mounted to the handlebar ends to channel the air through an air distribution channel in the hollow interior of the handlebar and discharges air through air-discharge openings in the hand-grip areas of the handlebars thus allowing air to cool and dry the bicycle-rider's palms to reduce fatigue.

It is a further object of the invention to provide a ventilation system that utilizes air captured through forward-facing air scoops mounted to the road-bike handlebars just inside of the location of the brake hoods and exhausts air through the hand-grips of the handlebars whereby the air is actually routed to rear-facing holes that allow air to flow internally in the handlebars, thus allowing air to cool and dry the bicycle-rider's palms to reduce fatigue.

It is another object of this invention to provide bicycle handlebar hand-grips that are perforated to allow air to flow through the handlebar perforations and then through the hand-grips and over the bicycle rider's palms to cool the rider and reduce muscle fatigue. The passage of air over the rider's palms will allow air to cool and dry the bicycle-rider's palms to reduce fatigue.

It is yet another related aspect of the invention to provide gloves that have palms that are heavily perforated with more than 30% and no more than 100% of the palm material removed that allows air to flow through and cool the palms of the bicycle rider, athlete, driver, equipment operator or manual laborer, thereby allowing air to cool and dry the use's palms to reduce fatigue.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features herein before set forth and as follows in the scope of the claims.

What is claimed is:

1. A ventilated handlebar comprising:
a. at least one hand grip area;
b. an air distribution channel having a first portion and a second portion;
c. the first portion of the air distribution channel having an air-intake component for directing air flow into the air distribution channel wherein the air-intake component comprises at least one aperture for introducing air through the air-intake component;
d. the second portion of the air distribution channel being engaged with at least one air-discharge opening to enable air to flow through at least one aperture of the air-intake component to where the air-discharge opening that is disposed on at least one hand grip area of the handlebar;
e. and, optionally, a handlebar grip that engages the handlebar grip area, where the handlebar grip contains a plurality of vent openings to allow the flow of air, and the vent openings on the handlebar grip are aligned with at least one air-discharge opening disposed on the handlebar hand grip area to permit the flow of air through said perforations in the handlebar grip.

2. The ventilated handlebar of claim 1 wherein the air distribution channel comprises the hollow interior of the handlebar.

3. The ventilated handlebar of claim 2 wherein the handlebar hand grip area has a plurality of air-discharge openings disposed within the handlebar hand grip area.

4. The ventilated handlebar of claim 2 wherein the second portion of the air distribution channel is connected to more than one air-discharge opening occurring disposed on at least two hand grip areas.

5. The ventilated handlebar of claim 2 wherein the air-intake component comprises a plurality of apertures oriented in the direction of forward travel of the equipment to which the handlebar is attached.

6. The ventilated handlebar of claim 2 wherein the air-intake component comprises at least one air scoop the opening of the air scoop oriented in the direction of the forward travel of the forward travel of the equipment to which the handlebar is attached.

7. A ventilated handlebar comprising:
a. at least two hand grip areas;
b. an air distribution channel having a first portion and a second portion wherein the air distribution channel is located within the hollow interior of the handlebar;
c. the first portion of the air distribution channel having an air-intake component for directing air flow into the air distribution channel wherein the air-intake component comprises a plurality of apertures;
d. the second portion of the air distribution channel being engaged with a plurality of air-discharge openings to enable air to flow through the plurality of apertures of the air-intake component to the air discharge openings, where the plurality of discharge openings are disposed on the hand grip areas of the handlebar;
e. and, optionally, a handlebar grip that engages the handlebar grip area, where the handlebar grip contains a plurality of vent openings to allow the flow of air, and the vent openings on the handlebar grip are aligned with the plurality of air-discharge openings disposed on the handlebar hand grip area to permit the flow of air from the handlebar grip.

8. Gloves that have heavily perforated palms with no less than 30% and no more than 100% of the palm material removed to allow air to flow through the palm area of the glove and cool the palms of the wearer.
